(19) United States
(12) Patent Application Publication
(10) Pub. No.: US 2017/0140488 A1
(43) Pub. Date: May 18, 2017

(54) STUDENT RECRUITMENT SYSTEM AND METHOD

(71) Applicants: ARTURO CAINES, HANOVER PARK, IL (US); Gerard Hajduk, GLENDALE HEIGHTS, IL (US); Lenin John, HAMILTON (CA); Samuel Zita, WOODRIDGE, IL (US)

(72) Inventors: ARTURO CAINES, HANOVER PARK, IL (US); Gerard Hajduk, GLENDALE HEIGHTS, IL (US); Lenin John, HAMILTON (CA); Samuel Zita, WOODRIDGE, IL (US)

(21) Appl. No.: 15/060,546

(22) Filed: Mar. 3, 2016

Related U.S. Application Data
(63) Continuation-in-part of application No. 14/943,193, filed on Nov. 17, 2015.

(51) Int. Cl. G06Q 50/20

(52) U.S. Cl. CPC G06Q 50/2053

(57) ABSTRACT

An integrated system and method, used by students and post-secondary educational institutions, allowing for a bi-directional exchange of information. The information going from the student to the post-secondary educational institution being credentialing and demographic in nature: age, GPA, test scores, interest, course of study, community service, extracurricular activity, and the like. The information going from the post-secondary educational institution to the student being degree requirements, course, cost per credit hour, extracurricular and sporting activities, cultural activities, fine arts activities, physical facilities, demographics, geographic, and meteorological.

### FIELD OF INVENTION

This invention relates to the field of data processing for education administration, guidance, and admission. Specifically, this invention is a system and method to provide post-secondary educational institutions with optimized candidates for recruitment.

### BACKGROUND OF INVENTION

The present invention is complementary to the invention disclosed in patent application Ser. No. 14/943,143, entitled, “Student Graduation Requirements Records System and Method,” which is incorporated herein, by reference.

PSEI (“PSEI”)—community colleges, colleges and universities—have gotten more expensive over the last two to three decades. Annual tuition and room-and-board increases have outpaced the Consumer Price Index (“CPI”) in the United States. A significant amount of money has gone to improving the physical plant of colleges and universities: labs, dormitories, dining halls, recreational facilities, sporting venues, and performance halls, inter alia. Many PSEI have spent considerable resources improving their technology: lab equipment, computers, wireless networks, mobile applications to interface with students, inter alia.

However, when it comes to recruiting students, most colleges and universities do the same types of things they have been doing for the last 30 years. They get lists of prospective students from the SAT and ACT test providers, high schools, and other providers. They supplement these lists with their internal recruiting channels, such as websites and tours. Some students, themselves, contact PSEI, directly. Then the PSEI send mail and email to all of the students, without much individualized focus, or consideration about whether the student would be a good match for the institution. The results for most students is a cluttered mailbox, both U.S. and electronic. The results for most PSEI are that they waste considerable money and other resources on students who are not going to come to their institution. Many PSEI accept significantly less than half of the applicants, creating gross systemic waste.

Additionally, there is a great likelihood that the PSEI are still not reaching students who would be a good fit. The current systems rely on information pushed from the PSEI to the prospective student. Little information is provided to the PSEI about the student during the recruiting process. All of the information moving from the student to the university happens during the application process. Additionally, PSEI only receive information concerning students who have expressed some interest in the PSEI, when they contact the PSEI. With the cost of post-secondary education, such recruiting inefficiency is highly suboptimal.

The Federal Department of Education (“DOE”) is the largest single post-secondary education funding source in the United States. DOE has implemented standards which track the 6 year graduation rates of students. Such measures are difficult for many PSEI to answer, accurately and automatically, due to their legacy data systems. Current PSEI data systems are highly siloed, significantly limiting the amount of data analytics that can be performed.

Additionally, graduation reporting places community colleges and less prestigious colleges and universities at a distinct disadvantage, for a number of reasons. First, many students who start their post-secondary education at these institutions, eventually transfer to another institution. Second, a higher percentage of students at these institutions are only attending part-time, meaning that it can take significant time for the student to achieve a four-year degree. Third, many of the students at community colleges are adult learners, who do not intend to get a degree. Rather, they are attending community college to improve their knowledge, improve their job skills, or for simple edification.

In a March 2015 report by the American Association of Community Colleges, only 26.1% of the students who first enroll at a community college achieve their initial degree at that same institution within six years. However, over 57% of the students who first enroll at a community college, either (1) achieve their initial degree at the same institution within six years; (2) complete their degree at a different four year institution within six years; (3) achieve their initial degree at a different two year institution within six years; or (4) are still enrolled in an post-secondary educational institution.

At four-year institutions, for the latest full year reported (2013), the National Center for Education Statistics reports that 59% of first-time, full-time students who began seeking a bachelor's degree at a 4-year institution in fall 2007 completed the degree at that institution by 2013. The 6-year graduation rate at was 58% at 4-year public institutions, 65% at 4-year private nonprofit institutions, and 32% at 4-year private for-profit institutions. Men graduated at a rate of 56%; women at a rate of 62%. The graduation rate was higher for woman than for men at both public (60% vs. 55%) and private nonprofit institutions (68% vs. 62%). Men graduated at a higher rate at private for-profit institutions (36% vs. 28%). Clearly, with over ⅓ of enrolling students failing to graduate in 6 years, the recruitment process is not fulfilling its purpose of identifying and attracting students who will be successful at a PSEI.

Now, with the DOE requiring higher six year degree completion rates, all PSEI need a tool that allows them to better predict those students who will be successful, and gives them a way to recruit those students. There are many technical and administrative improvements being implemented in order to make the requirement easier. One of these administrative improvements is a movement towards establishing a common course coding system.

A tool allowing students to compare and contrast PSEI would have at least two significant advantages for students: (1) it would allow students to be self-selective during the recruiting process, finding institutions that best fit their needs; and (2) it would allow students to better plan the cost of a post-secondary degree. Due to the ever escalating cost of post-secondary education, a significant portion of the student population take classes at lower priced community colleges and public 4-year institutions before transferring to a higher priced public 4-year institutions or a private 4-year institution. The available permutations to assemble degree requirements are large. Cost-conscious students want to maximize the number of classes taken at low-cost institutions, and are willing to take courses at a number of different post-secondary institutions. Some of the cost-conscious students begin with a plan, understanding which classes they will take at the community college, and what university they will transfer to in the future.

For these cost-conscious students, the ability to know what classes are offered at a community college, and how they fit into a degree program at a different institution, is paramount. The move to common course coding will make this behavior easier, most likely increasing the number of students who take classes at multiple PSEI. Currently, however, these students read course catalogs for both institutions, and try to divine what may, and what may not, transfer. At best, this is a headache. Adding to the headache, many students change majors, or interest, while in college. These students need a tool that allows them to track graduation requirements at various institutions, and compare the graduation requirements of various degree programs using their completed and current coursework.

Additionally, many other cost-conscious students begin their post-secondary education without a clear vision of how they will finish their post-secondary education. For these students, post-secondary progress is an ad hoc activity, in which the student fitfully advances towards an amorphously defined future. These students also need a tool that allows them to track graduation requirements at various institutions, and compare the graduation requirements of various degree programs with their completed and current coursework. To maximize utility, such a tool should allow the user to compare various degree programs at various institutions, allowing a student to assess which institution and degree program is most advantageous, given the students completed coursework and financing. Currently, the solutions are painfully manual.

### PRIOR ART REVIEW

In order to overcome the large problem of poor PSEI recruiting tools, a solution must overcome disjointed databases containing transcript information, poor analytics, byzantine degree requirements, government reporting requirements, and lack of accurate prospective student information. The idealized solution to the above problem would allow both post-secondary institutions and students to optimize their schedule, and it would allow the post-secondary institution to identify and recruit the most capable students, while simultaneously allowing the student population to compare and contrast graduation paths at various post-secondary institutions. Such a solution would create profiles for prospective post-secondary students, while they are still in high school. It would allow the student to assess the suitability of many PSEI based on their degree programs, graduation requirements, costs, and entrance requirements. It would allow PSEI to recruit students based off of their grade point average (“GPA”), SAT/ACT test scores, extracurricular activities, community service, geographic location, demographic information, household income, and chosen course of study, inter alia. Students would be tracked during the recruiting process, and through their post-secondary educational experience, with an application that can be loaded onto a smartphone or other portable electronic device. The application would associate a student with a permanent record, allowing post-secondary institutions to use analytics to identify suitable prospective students, and to track those students, throughout their post-secondary education, for DOE reporting purposes. The application would allow the student-users to compare and contrast the graduation requirements of various degree programs and institutions, by querying a plurality of servers and databases that contain the graduation requirements for a variety of degree programs at a variety of institutions, and compare them to the user's chosen course of study, which is stored, either locally on the phone, or on a remote server and database. The application should be able to compare the path to completion for a variety of institutions and degree programs.

There is a substantial amount of prior art dealing with data processing for educational institutions, but nothing close to the idealized system. Most of the prior art is concerned with various aspects of academic resource planning and credentialing. For example, a number of patents disclose various aspects of systems to schedule post-secondary classes. For example, U.S. Pat. No. 7,805,107, by named inventor Shaver, entitled, “Method of student course and space scheduling” (“Shaver '107”); U.S. Pat. No. 8,224,757, by named inventor Bohle, entitled, “Curriculum management system” (“Bohle '757”); and U.S. Pat. No. 7,882,041, by named inventors Gibbons, et. al., entitled, “System and method for optimizing the effectiveness of an educational institution” (“Gibbons '041”). There are several problems with each of these patents. First, Shaver '107 anticipates that the post-secondary institution gives it the degree requirements, which is a process fraught with potential error. Shaver '107 anticipates that the course requirements will be provided in a fashion that will allow the computer to determine a population of still-required courses. The reality of modern post-secondary education is that many classes can fit multiple graduation requirements for multiple degree programs. In order to optimize scheduling, a solution must somehow map all of the uses for which each class can be used for each offered degree program. In addition to deficiencies with the schedule aspects of Shaver '107, it does not give students unfettered access to a planning facility that allows the student to compare and contrast future course offerings. Neither does Shaver '107 track students as they move from one institution to another institution. Although an interesting piece of prior art, Shaver '107 is a suboptimal solution for the stated reasons.

Bohle '757 teaches class scheduling software that allows users to sign up for classes, creates an attendance link, and associates each course with a particular curriculum. Bohle '757 teaches using links to adjust student class schedules when a particular class offering changes or is cancelled. Gibbons '041 teaches a system and method for taking course selection input from a student body population, aggregating the overall course demands, and then making a plan to dynamically allocate resources to meet the overall course requirements. Most of the scheduling patents suffer the same types of problems as Shaver '107, Bohle '757, and Gibbons '041. Further recitation would be merely cumulative.

There are patents that attempt to provide cross-institutional curriculum management, such as U.S. Pat. No. 8,620,831, by named inventor Adams, entitled, “Student-centered, cross-institutional curriculum management system apparatus and method” (“Adams '831”). Adams '831 teaches a system and method that compares curriculum between institutions, mining course catalogs for requirements. Adams '831 then translates like-text into like-requirements, between institutions. A student can then plan out a degree program at a first educational institution, while taking classes at both a first educational institution and a second educational institution. The schedule meeting the student's preset requirement for attaining a desired degree, taking a particular course load, and going to school on particular days and times. Although Adams '831 is an interesting concept, it requires a third party to intermediate the catalog offerings of the first educational institution and the second educational institution. The third party would delimit the text of the course catalog offerings of the educational institutions, would define XML labels for analogous text, and would have the educational institutions embed the XML labels in their respective online catalogs. Adams '831 moves the prior art in an interesting direction, but it is difficult to get many large institutions to agree to embed XML text on their webpages. Adams '831 is of limited use because it also does not help the educational institutions to track the future education of the student. Adams '831 also fails to use the common course coding that is being implemented across PSEI. The system itself will never be widely implemented because of those impediments.

A couple of related credentialing systems have interesting aspects, U.S. Pat. Nos. 8,554,584 and 8,290,797, both by named inventor Hargroder, both entitled, “Interactive credential system and method” (“Hargroder '584” and “Hargroder '797”). Hargroder '584 and Hargroder '797 are concerned with insurance credentialing or underwriting. These patents disclose a credential system and method comprising a database containing employee-employer-applicant surveyed information, industry specific criteria, such as insurance loss history and account performance, an authorization code for authorizing access to the database and a control device, operatively associated with the database, for presenting weighted scores. Hargroder '584 and Hargroder '797 teach a method and system for reducing an entity's or person's insurance loss history and account performance to a single numeric metric. These patents, although in an unrelated field, disclose a method for authorizing the access of confidential information stored on a plurality of databases by a plurality of institutions. Hargroder '584 and Hargroder '797 also teaches updating or augmenting loss information of an entity or person, stored by one institution, with the loss information of a second institution.

A last piece of relevant prior art are those systems that match student records across institutions, such as U.S. Pat. No. 8,676,823, by named inventors Shapiro, et. al., entitled, “Efficient student record matching” (“Shapiro '823”). Shapiro '823 teaches a system and method for matching student enrollment records. The method comprises accessing a student's enrollment record at a first educational institution, creating common variations in the spelling of the student's name, and searching additional educational institutions for additional records. The method relies on a historical name variation database. In a preferred embodiment, Shapiro '823 uses a matching algorithm to account for common variations in student names and geographical distances between secondary institutions and the student's current known address to generate higher confidence matches. Shapiro '823 is envisioned as allowing educational institutions to track student progress from secondary to postsecondary institutions and generate statistics about aggregate college enrollment rates to inform policy decisions. Shapiro '823 does not aggregate records between a plurality of post-secondary institutions for the same student, although, conceivably, it could. Shapiro '823 merely provides a method for record matching, and exemplifies the prior art with respect to that aspect of its design.

In addition to the above cited patents, and others like them, there are commercial solutions in the prior art. One is the Oracle's/PeopleSoft's Campus Solutions. As with most comprehensive solutions, Campus Solutions is both overly broad and underly capable. Campus Solutions tries to be an end-to-end people and process management solution for universities, managing enrollment, degree tracking, financial aid, and other university management functions. The package includes multiple modules that can be added on to customize a solution. In the end, the solution does not allow an institution to track its former students progress at other institutions. It also fails to provide students with a tool to compare and contrast the remaining requirements for graduation in different degree programs. Perhaps the biggest drawback is that Campus Solutions does not appear to have a method to determine the aggregate remaining courses for either a single student or a student population. Campus Solutions is a legacy of an era of data warehousing in which massive applications tried to store all enterprise data on a dedicated database. The current direction of data processing technology is to allow data to remain in its native environment, accessing it when necessary and storing only unique data transforms on a dedicated database related to the data processing application.

The prior art has failed to create a complete solution to the inter-related problems of determining the remaining courses required, both individually, and in the aggregate, in order to meet graduation requirements, tracking post-secondary student progress through multiple institutions, and assessing graduation requirements for a particular student with respect to a plurality of PSEI and/or a plurality of degree programs. Because of the heightened reliance, in the United States, on community colleges as part of the solution for the high cost of post-secondary education, student tracking and graduation requirements tracking have become a merged issue, which is exacerbated by the inefficiencies in the PSEI' databases.

### SUMMARY OF THE INVENTION

The present invention is an integrated system and method that allows bi-directional information and communication exchange between a plurality of past, prospective and current students, on the one hand, and a plurality of PSEI, employers, and service providers, on the other hand. In one embodiment, the present invention includes a portal database. The portal database, accessible through a portal server, is connected to a plurality of PSEI databases, through a combination of secure circuitry and software. The portal database includes raw and transformed student data from the plurality of PSEI databases. A plurality of students can interact with the portal database, through an application installed on the student's electronic device. In order to access the portal database, a student must create a profile. The plurality of PSEI can access the portal database as a multi-tenancy tool. A multi-tenancy tool is a cloud-based architecture in which the software application runs on the portal server, and provides each user, or tenant, access to an instance of the program, with all its attendant capabilities and data. The plurality of PSEI can use analytics on the portal database, to find student profiles that are attractive to the PSEI.

In a second embodiment, the plurality of PSEI can access the portal database using a PSEI application and the secure connection. In this embodiment, the plurality of PSEI can still use analytics on the portal database, to find student profiles that are attractive to the PSEI. In a third embodiment, the plurality of students access the portal database using a multi-tenancy tool.

The student portal refers to either an application resident on the student's electronic device or to a multi-tenancy access tool. The student portal would connect to the portal database using the internet, a wireless connection, or a combination of both. The student portal is an interactive application for a smartphone, laptop, or other electronic device, connecting the student to a plurality of post-secondary educational institutions, through the portal database. The student gets access to bi-directional information flow concerning a plurality of PSEI by entering a profile, including GPA, SAT/ACT test scores, extracurricular activities, community service, geographic location, demographic information, household income, and chosen course of study, inter alia. Once the student creates a profile, the student has access to information concerning a plurality of PSEI, allowing the student to compare and contrast different PSEI for degree programs, course offerings, costs, locations, and other attributes. The student's post-secondary educational progress is added, in real time, as the student progresses through college. Penultimately, the student portal is used by the student to minimize cost, time, or other factors in getting their post-secondary degree. Ultimately, the student portal is used, at the termination of the student's studies, as a further recruiting portal for job recruiting.

The PSEI portal refers to either an application resident on the student's electronic device or to a multi-tenancy access tool. The PSEI portal allows each of a plurality of PSEI to access all of the students who have entered profiles. The PSEI can assess each student profile and compare it to their current selection criteria. The PSEI portal has analytics, allowing the institution to run analysis of variance (“ANOVA”) comparing a single dependent variable (such as a graduation attribute) to multiple independent variables (such as secondary GPA, ACT/SAT test scores, community service, geographic location, demographic information, household income, and chose course of study). The PSEI portal analytics allows multiple analysis of variance (“MANOVA”), in which two or more dependent variables (e.g., graduation attribute, GPA, degree, etc.) are compared to multiple independent variables. Other analytic tools are also accessible. Through analytics, each participating PSEI quickly identifies which prospective students are most likely to succeed, allowing the institution to pinpoint its recruiting efforts. The PSEI can also use its portal to identify likely sources of alumni contributions, track graduation rates, plan course offerings and degree programs, and identify tangible and intangible characteristics that attract the most successful students.

The system and method hard codes degree requirements in software, converting them into Boolean and/or algebraic expressions. The expressions have Boolean aspects because the student has either taken a required course or has not taken a required course. Or the student has met a pre-requisite to take a course, or has not met a pre-requisite to take the course. Some expressions are combined algebraic and Boolean expressions, because, for example, a student might be required to take three English course or three math courses. The requirement is only met once the student has taken all the courses, but each completed course still counts toward a graduation requirement for credit hours. For lack of a more elegant term, the requirement equations and equation sub-components will be referred to algebraic Boolean expressions. The total credit hour requirement for graduation is an algebraic Boolean sum. In some degree programs, there may be intermediate algebraic Boolean sums, when a degree program requires a major or minor with a particular number of credit hours. Each degree program can be defined as a set of required and elective courses, until the student reaches a pre-set number of credits.

The requirements for each degree program are publically available for all post-secondary institution, and typically reside in the post-secondary institution's course catalog or website. Each class relates to each degree program in one of a number of defined ways, called uses, such as prerequisite, requirement, elective, or no relationship. Often, a class may meet one or more uses for a specific degree program, but may only be used for a single use, meaning that logic must be used to determine the most advantageous use for each class for each student. The set of all uses for all degree programs for a specific course is defined as the course's universe. A text engine can be used to translate the course requirements into logic requirements.

The system and method can calculate the minimum required set of classes required for each student in attendance, by maximizing the degree program uses for the student's completed coursework. Such an optimization routine can be accomplished by loading all possible course use algebraic Boolean expressions for a given student into a matrix, solving for the minimum or maximum. Each student can then track their progress towards graduation. Additionally, each PSEI can monitor each student's progress towards degree completion.

A plurality of PSEI are all similarly enabled with an integrated system and method that tracks both current, past and prospective students. The plurality of PSEI can use targeted recruiting to find students that would be most ideal for their institution.

A plurality of students are all similarly enabled with an integrated student system and method that allows each student to (1) choose what information is shared with the public, the plurality of PSEI, and other students; (2) assess requirements for various degree-paths at various PSEI; (3) interact, on a peer-to-peer basis, with other similarly situated students; (4) research scholarships, internships, fellowships, and benefits (such as the G.I. Bill); (5) apply for scholarships, internships, fellowships, and benefits (such as the G.I. Bill); (6) review PSEI aspects such as courses, instructors, financial aid process, scheduling process, career counseling, and social life; (7) access third-party goods and services such as career counseling, job placement, resume writing services, computers and electronics, software, and travel; and (8) research and apply for jobs.

### BRIEF DESCRIPTION OF THE DRAWINGS

There are 8 relevant drawings.

FIG. 1 is high-level system diagram showing the functional blocks and the connections/circuitry.

FIG. 2 shows the logic Framework stack.

FIG. 3 shows the System Management functional blocks.

FIG. 4 shows the GUI Client.

FIG. 5 shows the Loader flow and functional block.

FIG. 6 shows the Degree Analyzer flow and functional block.

FIG. 7 shows the Curriculum Analyzer flow and functional block.

FIG. 8 shows the analytic engine/metadata views.

FIG. 9 shows the Profile Analyzer flow and functional block.

### DETAILED DESCRIPTION OF THE PREFERRED EMBODIMENTS

The following description represents the inventors' current preferred embodiments. The description is not meant to limit the invention, but rather to illustrate its general principles and utility. Examples are illustrated with the accompanying drawings. A variety of drawings are offered, showing multiple system components and multiple embodiments of the present invention.

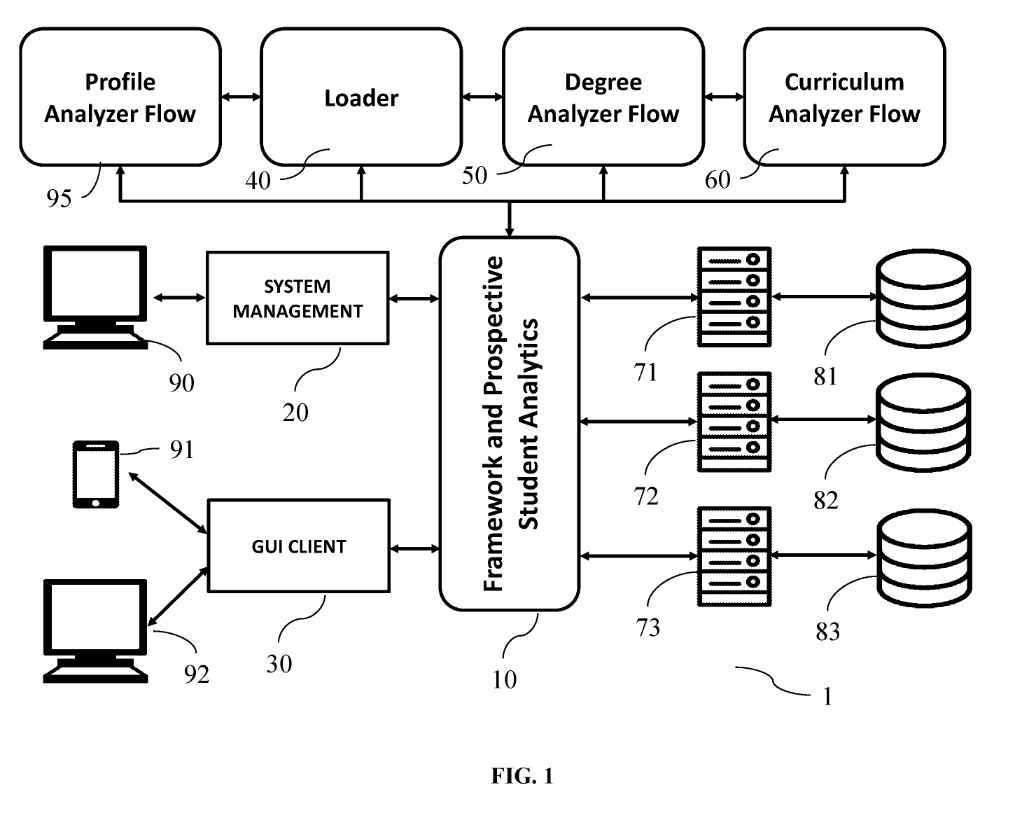

FIG. 1 shows the overall system diagram for the present invention. The invention allows input and access from users on computers/laptops 92 or mobile devices 91 through a graphic user interface (“GUI”) client 30. The invention allows post-secondary educational institution (“PSEI”) administrators to control users and system management 20 from computers/laptops 90.

The system of the present invention is controlled and operated through a framework, prospective student analytics server, and portal database (collectively, “portal server”) 10. The portal server 10 is connected to a plurality of PSEI servers 71, 72, 73. The connections are a combination of software and circuitry that can vary from college to college. The plurality of PSEI servers 71, 72, 73 connects the portal server to PSEI database repositories 81, 82, 83. The PSEI database repositories 81, 82, 83 store data on students, curriculum, degrees, course, facilities, extracurricular activities, cultural activities, and sporting activities, inter alia. The portal server 10 allows the loader 40, degree analyzer operation 50, and curriculum analyzer operation 60 to interact with, and create transforms of, the PSEI data on students, curriculum, degrees, course, facilities, extracurricular activities, cultural activities, and sporting activities.

A student portal application is loaded on the plurality of student mobile devices 91, or, alternatively, the student portal application is accessible through a multi-tenancy tool deployable on a student mobile device 91, provided the student has created a student profile or account. The student portal application allows the student access to analytics on the portal server 10, so that the student can compare and contrast various aspects of PSEI's. In order to gain access, a student must complete a student profile, containing, at a minimum, GPA, SAT/ACT test scores, extracurricular activities, community service, geographic location, demographic information, household income, interests, and chosen course of study. The student portal application is designed to datamine, gaining access to the correct repositories to access native and unaltered student data.

A PSEI portal application is resident on each of the plurality of PSEI servers 71, 72, 73. Alternatively, the PSEI portal application is a multi-tenancy tool which is accessible through the PSEI servers 71, 72, 73. The PSEI portal application can use analytics provided by the portal server 10 to identify ideal students based off of the students' profiles. The profile matching algorithms use AN OVA, MANOVA, and various other analytical techniques to find the student profiles that most nearly match that of an ideal PSEI student. The PSEI can then use targeted marketing to recruit those students whom the PSEI believe would be the best fit for the institution. The PSEI can use targeted offers to attract the most desirable students.

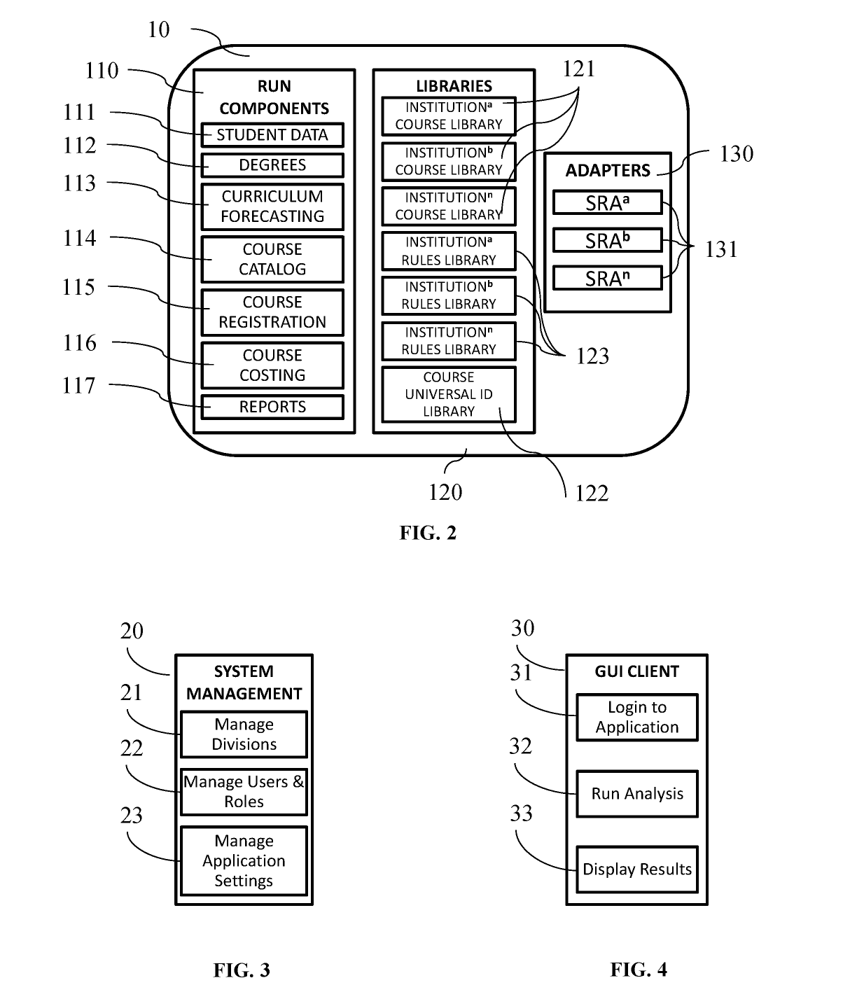

FIG. 2 shows the major components of the portal server 10: the run components 110; the libraries 120; and the adapters 130. The run components 110 include student data 111; degrees 112; curriculum forecasting 113; course catalog 114; course registration 115; course costing 116, and reports 117. The student data 111 consists both of data of current PSEI students and of prospective students. The portal server 10 can perform analytics, including ANOVA, MANOVA, and other analysis, using data from the libraries 120. The run components use the libraries 120, the loader 40, the degree analyzer operation 50, the curriculum analyzer operation 60, and the adapters 130. The libraries 120 include an institution course library 121 for each of the plurality of colleges. The libraries 120 also include an institution rules library 123 for each of the plurality of colleges. Lastly, the libraries 120 include a course universal ID library, which can allow for cross-referencing different course offerings between different colleges. The adapters include a system of records adapter (“SRA”) 131 for each of the plurality of colleges. The SRA 131 acts as an adaptation layer, putting all of the plurality of colleges' information into a standard information presentation format for processing.

In FIG. 3 and FIG. 4, the system management stack 20, and the GUI client 30 serve as an interface to the present invention, and interact with the portal server 10. The PSEI system management stack 20 includes a division management function 21, a facility to manage users and roles 22, and a facility to manage application settings 23 for a particular college or institution. The GUI client 30 includes a login 31, a run analysis interface 32, and a results display 33.

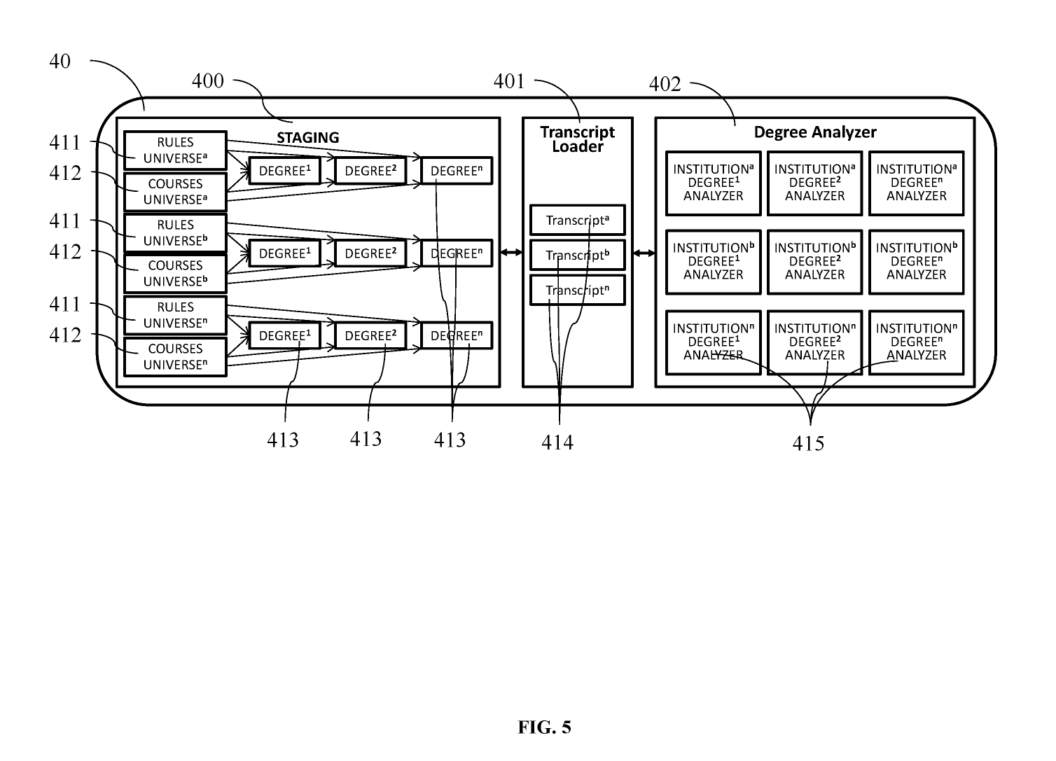

FIG. 5 shows the loader 40, which interacts with the portal server 10, the degree analyzer operation 50, and the curriculum analyzer operation 60. The loader has a staging method that includes a rules universe 411 and a course universe 412 for each college. The rules universe 411 defines all of the requirements that a college or university can have. The courses universe 412 defines all of the course offerings of a college or university. All of a college or university's plurality of degree programs 413 can be mathematically assembled from the rules universe 411 and the course universe 412. The transcript loader 401 loads the transcripts 414 for every student at every institution. The degree analyzer 402 has an institution degree analyzer 415 for each of the plurality of degree programs at each of the plurality of colleges. The degree analyzer 402, and each of the institution degree analyzers 415, is fed information from the degree analyzer operation 50, and the curriculum analyzer operation 60.

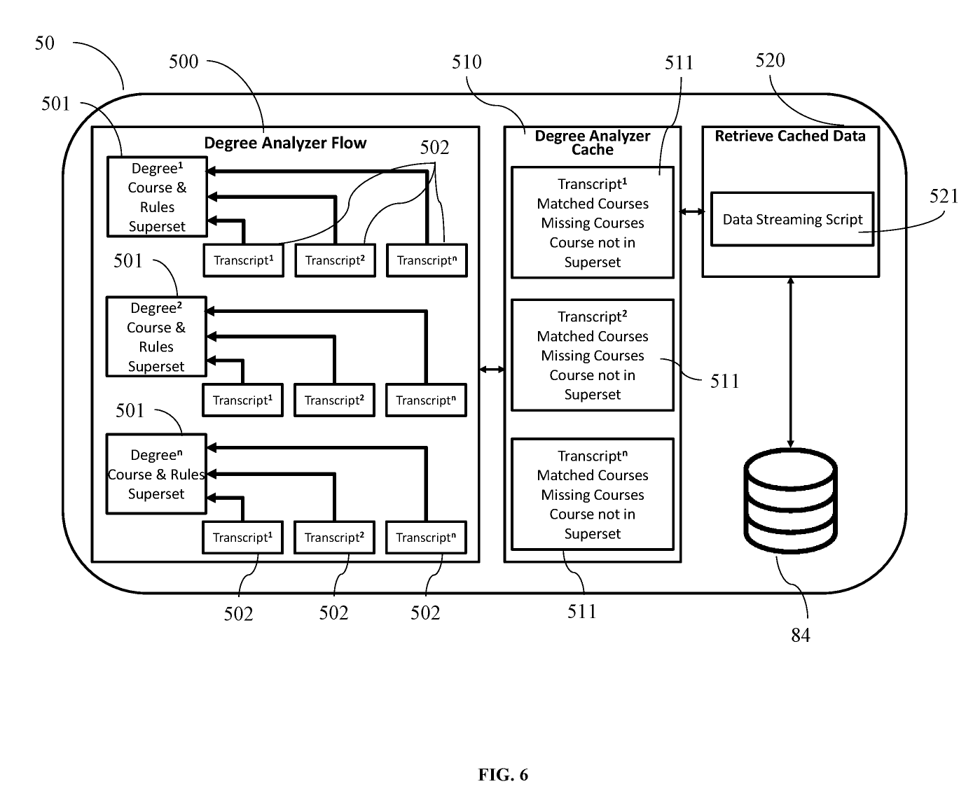

FIG. 6 shows the degree analyzer operation 50, which is comprised of a degree analyzer flow 500, a degree analyzer cache 510, a cache retrieval 520, and access to the present invention's database 84. The degree analyzer flow 500 is comprised of a degree course and rules superset 501 for each of the plurality of degrees at each of the plurality of colleges. The degree course and rules superset 501 is fed by all of the plurality of transcripts 502 for each of the plurality of students at each of the plurality of colleges. The degree analyzer flow 500 loads the degree analyzer 402. The degree analyzer flow 500 also interoperates with the degree analyzer cache 510. The degree analyzer cache 510 is comprised of a plurality of transcripts, matched courses, missing courses, and course not in the superset 511 for each of the plurality of transcripts for each of the plurality of students at each of the plurality of colleges. The degree analyzer cache 510 transfers data from the cached data retrieval 520 to the degree analyzer flow 500. The cache retrieval 520 is composed of a data streaming script 521 which accesses the data from the present invention's database 84.

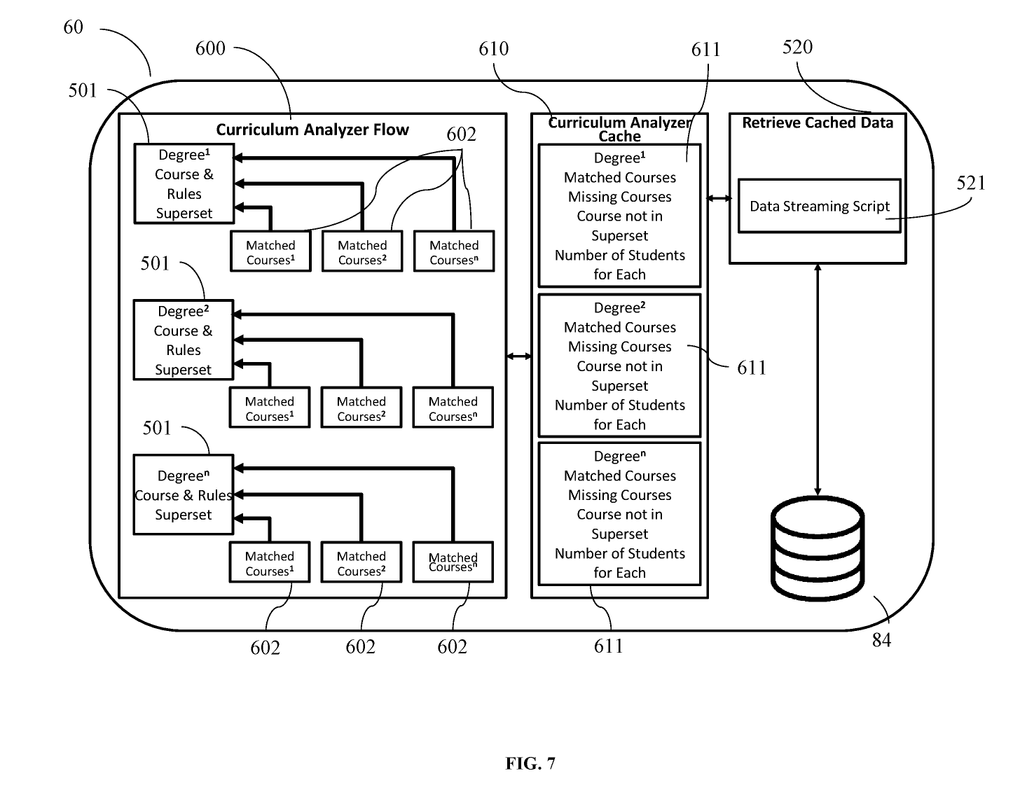

FIG. 7 shows the curriculum analyzer operation 60, which feeds the degree analyzer 402. The curriculum analyzer operation 60 is comprised of a curriculum analyzer flow 600, a degree analyzer cache 610 for the curriculum analyzer operation 60, a cache retrieval 520, and access to the present invention's database 84. The curriculum analyzer flow 600 is comprised of the degree course and rules superset 501 for each of the plurality of degrees at each of the plurality of colleges. The degree course and rules superset 501 is fed by all of the plurality of matched courses 602 for each of the plurality of degree programs at each of the plurality of colleges. The curriculum analyzer flow 600 loads the degree analyzer 402. The curriculum analyzer flow 600 also interoperates with the degree analyzer cache 610. The degree analyzer cache 610 is comprised of a plurality of degrees, matched courses, missing courses, course not in the superset, and the number of students for each of the foregoing 611 for each of the plurality of matched courses for each of the plurality of degree programs at each of the plurality of colleges. The degree analyzer cache 610 transfers data from the cached data retrieval 520 to the curriculum analyzer flow 600. The cache retrieval 520 is composed of a data streaming script 521 which accesses the data from the present invention's database 84.

The degree analyzer 402, comprised of an institution degree analyzer 415 for each of the plurality of degree programs at each of the plurality of colleges, constructs an algebraic Boolean expression out of the information supplied from the curriculum analyzer operation 60, the degree analyzer operation 50, the loaded transcripts 401, 414, and the rules universe 411, and courses universe 412 for each of the degree programs 413 at each of the plurality of colleges. The institution degree analyzer 415 determines whether each student and/or each transcript 414 meets the degree or graduation requirements using the algebraic Boolean expressions.

Using the analytics function and the degree analyzer 402, through the GUI 30 and portal server 10, the student portal application of the student mobile device 91 can assess the requirements of the plurality of PSEI using the analytics on the portal server 10. Using the analytics on the portal server 10, through the GUI 30, and the plurality of PSEI servers 71, 72, 73 and PSEI databases 81, 82, 83 the student portal application of the student mobile device 91 can assess research scholarships, internships, fellowships, and benefits (such as the G.I. Bill); apply for scholarships, internships, fellowships, and benefits (such as the G.I. Bill); and review PSEI aspects such as courses, instructors, financial aid process, scheduling process, career counseling, and social life. Accessing the portal database 84 and portal server 10, through the GUI 30, the student portal application can allow a student to choose what information is shared with the public, the plurality of PSEI, and other students; interact, on a peer-to-peer basis, with other similarly situated students; access third-party goods and services such as career counseling, job placement, resume writing services, computers and electronics, software, and travel; and research and apply for jobs.

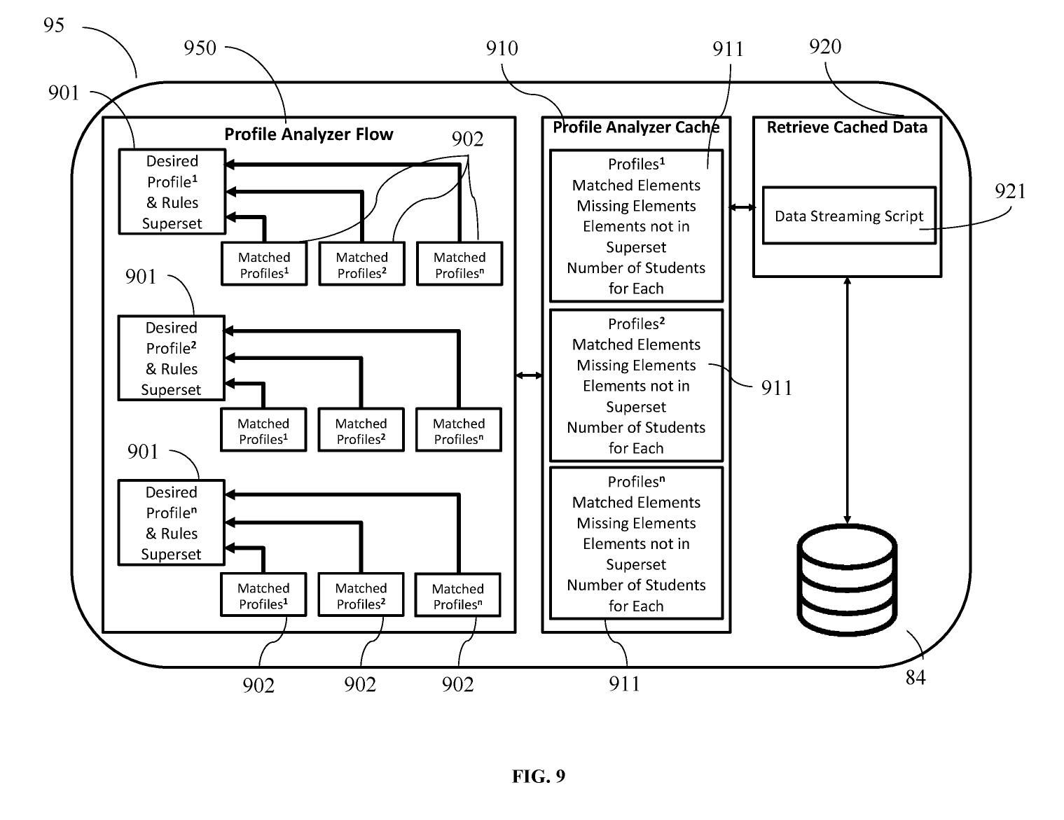

FIG. 9, shows the profile analyzer operation 95, which is comprised of a profile analyzer flow 950, a profile analyzer cache 910, a cache retrieval 920, and access to the present invention's database 84. The profile analyzer flow 950 is comprised of a desired profile and rules superset 901 for each of the plurality of degree programs at each of the plurality of PSEI. The desired profile and rules superset 901 is fed by all of the plurality of matched profile 902 for each of the plurality of students. The profile analyzer flow 950 loads the degree analyzer 402. The profile analyzer flow 950 also interoperates with the profile analyzer cache 910. The profile analyzer cache 910 is comprised of a plurality of profile, matched elements (demographic and academic information and measurements), missing elements, and elements not in the superset 911 for each of the plurality of profiles for each of the plurality of students at each of the plurality of PSEI or secondary schools. The profile analyzer cache 910 transfers data from the cached data retrieval 920 to the degree analyzer flow 950. The cache retrieval 920 is composed of a data streaming script 921 which accesses the data from the present invention's database 84.

Using the analytics function and the profile analyzer flow 950, through the GUI 30 and portal server 10, the PSEI portal application can assess the profiles of a plurality of prospective, current, and/or former PSEI students using the analytics on the portal server 10. The PSEI can use its own internal requirements, such as minimum grade point average, ACT/SAT test scores, demographic information, extracurricular information, and affiliations, to determine desired profile parameters. Using the analytics on the portal server 10, through the GUI 30, and the plurality of PSEI servers 71, 72, 73 and PSEI databases 81, 82, 83 the PSEI portal application 91 can target students with the desired profile parameters for recruitment. Students with desired profiles could be given special offers, such as reduced tuitions, scholarship, early admission, inter alia. The student with desired profiles would be notified of such an offer through the student portal application. The student could then respond to such PSEI offers. Additionally, the PSEI can provide targeted students with dashboard information about the PSEI's performance on key metrics, such as cost per credit hour, financial aid, job placement, internships, and study abroad programs. The targeted students can then use the information in their decision-making process. Such a targeted method of student recruiting and communication will reduce the overall cost of recruitment for PSEI. The PSEI can monitor the students who have received the communications, the ones have responded to the communication, and the ones that have clicked on a hyperlink. This allows the PSEI to continue communication with interested students.

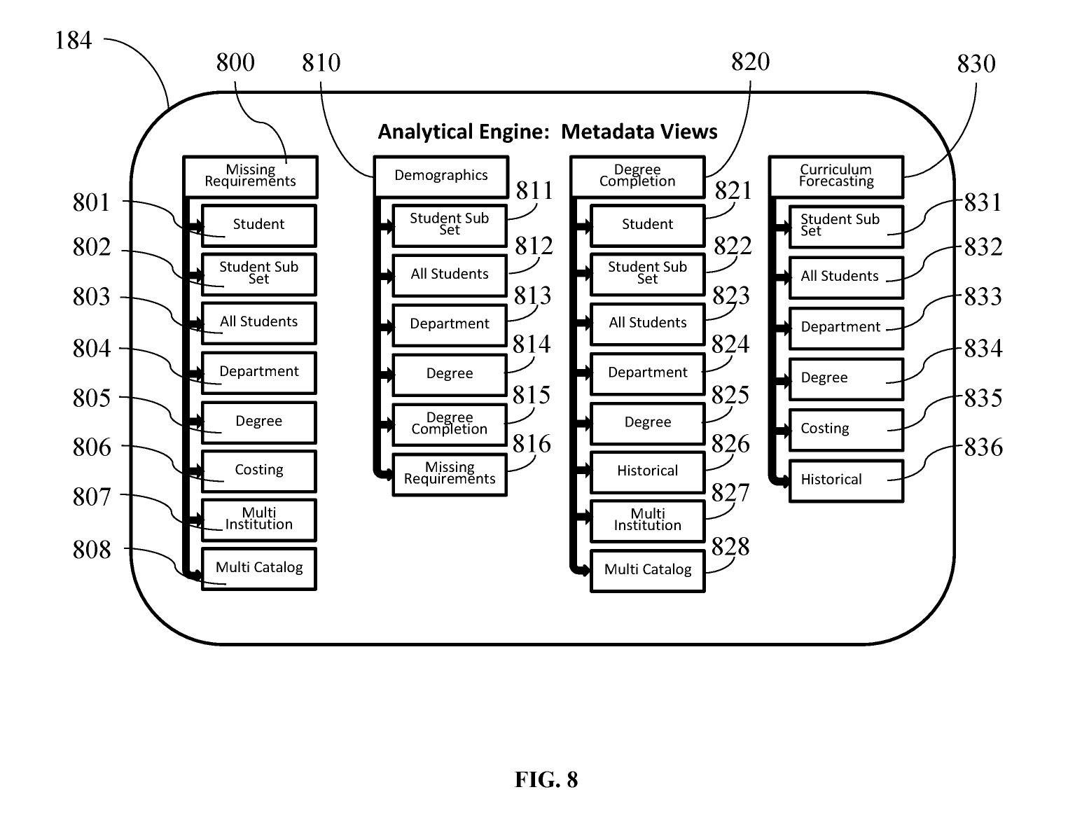

FIG. 8 shows an analytical engine database construct 184 for the present invention, resident on the portal database 84. The analytical engine database construct 184 stores metadata for missing requirements 800, demographics 810, degree completion 820, and curriculum forecasting 830. The missing requirements 800 is comprised of the missing requirements for each student 801, each defined student subset (e.g., by degree program or major) 802, all students 803, all departments 804, all degrees 805, all costing 806, multi-institution 807, and multi-catalog 808. The demographics is comprised of student subsets 811, all students 812, departments 813, degrees 814, degree completion 815, and missing requirements 816. The degree completion 820 metadata is comprised of student 821, student subset 822, all students 823, department 824, degree 825, historical 826, multi-institution 827, and multi-catalog 828. The curriculum forecasting 830 metadata is comprised of student subset 831, all students 832, departments 833, degree 834, costing 835, and historical 836.

PSEI can use the analytical engine 10, and analytical engine database construct 184 to perform analytics on students data 812, 821, 822, 823, 831, 832, and other constructs that are predictive of student performance, to find the most desirable students for the PSEI. The PSEI can then provide these students with focused marketing and recruiting efforts, using traditional recruiting methods, as well as SMS, email, and social media. The PSEI offers can be discounts, scholarships, special programs or student organization, preferred housing, and other perks to attract new students. Responses from the students come back into the portal.

I claim:

1. A method for bi-directional communication between a plurality of students and a plurality of post-secondary educational institutions (“PSEI”) comprising: a plurality of student mobile electronic devices; a plurality of PSEI servers; a portal server; a portal database, connected to and accessible through, the portal server; communication circuitry between the plurality of student mobile electronic devices and the portal server; communication circuitry between the plurality of PSEI servers and the portal server; a student portal application, embodied on a non-transitory computer readable medium, establishing a student profile for a portal-based mobile application service by entry of data into said student portal application; said student profile being communicated to the portal server, where the student profile is stored; a PSEI portal application, embodied on a non-transitory computer readable medium, establishing a PSEI profile for a portal-based application service by entry of data into said PSEI portal application; said PSEI profile being communicated to the portal server, where the PSEI profile is stored; allowing the plurality students, through the student portal application, to access, compare, and contrast the PSEI, one to another; and allowing each of the plurality of PSEI, through the PSEI portal application, to access, compare, and contrast the students, one to another.

2. The method for bi-directional communication between a plurality of students and a plurality of PSEI in claim 1, wherein the student profile is partially compiled by datamining already existing native source data, such as high school databases.

3. The method for bi-directional communication between a plurality of students and a plurality of PSEI in claim 1, wherein the student profile is comprised of secondary school grade point average (“GPA”), SAT/ACT tests scores, extracurricular activities, community service, geographic location, demographic information, interests, anticipated career path, anticipated educational path, and chosen course of study.

4. The method for bi-directional communication between a plurality of students and a plurality of PSEI in claim 3, wherein the student profile is further comprised of household income.

5. The method for bi-directional communication between a plurality of students and a plurality of PSEI in claim 1, wherein the PSEI portal application can communicate with the portal server and perform statistical analysis on the plurality of students.

6. The method for bi-directional communication between a plurality of students and a plurality of PSEI in claim 5, wherein each PSEI has the ability to use the statistical analysis on the plurality of prospective students, defined as students who are seeking a post-secondary education and a PSEI at which to study to identify or rank those students most likely to succeed at the PSEI.

7. The method for bi-directional communication between a plurality of prospective students and a plurality of PSEI in claim 6, where in the PSEI market and recruit those students who rank most likely to succeed at the PSEI.

8. The method for bi-directional communication between a plurality of students and a plurality of PSEI in claim 1, further comprising a method for analyzing the remaining required courses needed for completing a degree program for a selected student population at a plurality of PSEI comprising obtaining the graduation requirements for all degree programs at each PSEI; converting the graduation requirements into a set of algebraic Boolean expressions; creating the appropriate algebraic Boolean sum to indicate that the degree or course of study requirements have been met; identifying, for each course offered at each post-secondary educational institution, all of the uses for which the course may be used in meeting the requirements for all of the degree programs; accessing a student's record of completed course work, for each selected student who has attended one or more of the plurality of PSEI, and determining the remaining classes needed to complete the student's chosen or declared degree program at the student's current post-secondary educational institution.

9. The method for bi-directional communication between a plurality of students and a plurality of PSEI in claim 8, wherein a subset of the plurality of students, designated a plurality of prospective students, defined as students who are seeking a post-secondary education and a PSEI at which to study, use the student portal application to investigate and seek a PSEI.

10. The method for bi-directional communication between a plurality of students and a plurality of PSEI in claim 9, wherein the plurality of prospective students continue to use the student portal application once they enroll at a PSEI and become PSEI students.

11. The method for bi-directional communication between a plurality of students and a plurality of PSEI in claim 10, allowing each of the plurality the PSEI student to see the remaining course work required to graduate in any of the degree programs at any of the plurality of PSEI, using the PSEI student's currently completed course work.

12. The method for bi-directional communication between a plurality of students and a plurality of PSEI in claim 11, further comprising allowing each of the plurality of PSEI students to calculate the cost of completing each degree program at any of the plurality of educational institutions, using the student's financial aid record, most recent Free Application for Federal Student Aid, or equivalent, and extrapolating, from a historical database, the estimated cost per credit hour the student would have to pay at each post-secondary educational institution.

13. The method for bi-directional communication between a plurality of students and a plurality of PSEI in claim 12, further comprising allowing each of the plurality of PSEI students, using student portal application and an estimated cost per credit hour for each class for each degree program for each post-secondary educational institution, to aggregate a total cost for each degree program at each post-secondary educational institution, and allowing said student to compare the cost for each degree program at each post-secondary educational institution.

14. The method for bi-directional communication between a plurality of students and a plurality of PSEI in claim 1, wherein the student portal application is resident on the student mobile electronic device, embodied on a non-transitory computer readable medium as a software method.

15. The method for bi-directional communication between a plurality of students and a plurality of PSEI in claim 1, wherein the student portal application is a multi-tenancy tool, accessible through a student mobile electronic device once the student has completed a student profile.

16. The method for bi-directional communication between a plurality of students and a plurality of PSEI in claim 1, wherein the PSEI portal application is resident on the PSEI server, embodied on a non-transitory computer readable medium as a software method.

17. The method for bi-directional communication between a plurality of students and a plurality of PSEI in claim 1, wherein the PSEI portal application is a multi-tenancy tool, accessible through the communication link, between the portal server and the PSEI server.

18. The method for bi-directional communication between a plurality of students and a plurality of PSEI in claim 1, wherein each student, accessing the method through a student portal application, can do at least one of the following actions: choose what information from the student's profile is shared with the public, the plurality of PSEI, and other students; access requirements for a plurality of degree-programs at a plurality of PSEI; interact, on a peer-to-peer basis, with other similarly situated students; research scholarships, internships, fellowships, and benefits; apply for scholarships, internships, fellowships, and benefits; review PSEI aspects such as courses, instructors, financial aid process, scheduling process, career counseling, and social life; access third-party goods and services such as career counseling, job placement, resume writing services, computers and electronics, software, and travel; and research and apply for jobs.

19. The method for bi-directional communication between a plurality of students and a plurality of PSEI in claim 18, wherein each student who is a former member of the United States' military, may access, through a student portal application, at least one additional software method relevant to former military members, such as GI Bill information; information and applications for benefits available only to veterans; preferences available only to veterans; special academic credits available to veterans; and licenses that are available to veterans.

20. The method for bi-directional communication between a plurality of students and a plurality of PSEI in claim 1, wherein each PSEI, accessing the method through a PSEI portal application, can choose targeted student profiles, called desired profiles, that correspond to the PSEI's internal recruitment requirements, such as grade point average, ACT/SAT test scores, demographic information, extracurricular participation, and affiliations.

21. The method for bi-directional communication between a plurality of students and a plurality of PSEI in claim 20, wherein a PSEI can offer students with desired profiles targeted inducements which include at least one of reduced tuition, financial aid, scholarships, early admission, and early decision.

22. The method for bi-directional communication between a plurality of students and a plurality of PSEI in claim 21, wherein students possessing the desired profiles can communicate acceptance or rejection of targeted inducements to the PSEI.

23. The method for bi-directional communication between a plurality of students and a plurality of PSEI in claim 20, wherein each PSEI can target communication to prospective students possessing desired profiles using a dashboard that contains information about at least one of the following: graduation rate, placement rate, acceptance rate, financial aid rates, financial aid averages, internship rate, and study abroad rates.

24. The method for bi-directional communication between a plurality of students and a plurality of PSEI in claim 23, wherein each PSEI can monitor student response to targeted communications, wherein the monitoring allows, at a minimum, the PSEI to see which students have received a communication, which students have responded to a communication, and which students have opened a hyperlink contained in the communication.

25. A system for bi-directional communication between a plurality of students and a plurality of PSEI comprising a plurality of student mobile devices; a plurality of PSEI databases; a plurality of PSEI servers; a portal central processing unit and server; communication circuitry between the plurality of PSEI servers and the portal server; a student portal application, resident on each of the plurality of student mobile electronic devices, embodied on a non-transitory computer readable medium, establishing a student profile for a portal-based mobile application service by entry of data into said student portal application; said student profile being communicated to the portal server, where the student profile is stored; a PSEI portal application, resident on each of the plurality of PSEI servers, embodied on a non-transitory computer readable medium, establishing a PSEI profile for a portal-based application service by entry of data into said PSEI portal application; said PSEI profile being communicated to the portal server, where the PSEI profile is stored; allowing students, through the portal-based mobile application, to access, compare, and contrast the PSEI, one to another; and allowing each of the plurality of PSEI, through the PSEI portal application, to access, compare, and contrast the students, on to another.

26. The system for bi-directional communication between a plurality of students and a plurality of PSEI claim 25, wherein the student profile is partially compiled by datamining already existing native source data, such as high school databases.

27. The system for bi-directional communication between a plurality of students and a plurality of PSEI claim 25, wherein the student profile is comprised of secondary school grade point average (“GPA”), SAT/ACT tests scores, extracurricular activities, community service, geographic location, demographic information, interests, and chosen course of study.

28. The system for bi-directional communication between a plurality of students and a plurality of PSEI claim 27, wherein the student profile is further comprised of household income.

29. The system for bi-directional communication between a plurality of students and a plurality of PSEI claim 25, wherein the PSEI portal application can communicate with the portal server and perform statistical analysis on the plurality of students.

30. The system for bi-directional communication between a plurality of students and a plurality of PSEI claim 29, wherein each PSEI has the ability to use the statistical analysis on the plurality of prospective students who are seeking post-secondary education to identify or rank those students most likely to succeed at the PSEI.

31. The system for bi-directional communication between a plurality of prospective students and a plurality of PSEI claim 30, where in the PSEI market and recruit those students who rank most likely to succeed at the PSEI.

32. The system for bi-directional communication between a plurality of students and a plurality of PSEI claim 25, further comprising a method for analyzing the remaining required courses needed for completing a degree program for a selected student population at a PSEI comprising obtaining the graduation requirements for all degree programs at each PSEI; converting the graduation requirements into a set of algebraic Boolean expressions; creating the appropriate algebraic Boolean sum to indicate that the degree or course of study requirements have been met; identifying, for each course offered at each post-secondary educational institution, all of the uses for which the course may be used in meeting the requirements for all of the degree programs; accessing a student's record of completed course work, for each selected student who has attended one or more of the plurality of PSEI, and determining the remaining classes needed to complete the student's chosen or declared degree program at the student's current post-secondary educational institution.

33. The system for bi-directional communication between a plurality of students and a plurality of PSEI claim 32, wherein a subset of the plurality of students, designated a plurality of prospective students, defined as students who are seeking a post-secondary education and a PSEI at which to study, use the student portal application to investigate and seek a PSEI.

34. The system for bi-directional communication between a plurality of students and a plurality of PSEI in claim 33, wherein the plurality of prospective students continue to use the student portal application once they enroll at a PSEI and become PSEI students.

35. The system for bi-directional communication between a plurality of students and a plurality of PSEI claim 34, allowing each of the plurality the PSEI student to see the remaining course work required to graduate in any of the degree programs at any of the plurality of PSEI, using the PSEI student's currently completed course work.

36. The system for bi-directional communication between a plurality of students and a plurality of PSEI claim 35, further comprising allowing each of the plurality of PSEI students to calculate the cost of completing each degree program at any of the plurality of educational institutions, using the student's financial aid record, most recent Free Application for Federal Student Aid, or equivalent, and extrapolating, from a historical database, the estimated cost per credit hour the student would have to pay at each post-secondary educational institution.

37. The system for bi-directional communication between a plurality of students and a plurality of PSEI claim 36, further comprising allowing each of the plurality of PSEI students, using student portal application and an estimated cost per credit hour for each class for each degree program for each post-secondary educational institution, to aggregate a total cost for each degree program at each post-secondary educational institution, and allowing said student to compare the cost for each degree program at each post-secondary educational institution.

38. The system for bi-directional communication between a plurality of students and a plurality of PSEI in claim 25, wherein the student portal application is resident on the student mobile electronic device, embodied on a non-transitory computer readable medium as a software method.

39. The system for bi-directional communication between a plurality of students and a plurality of PSEI in claim 25, wherein the student portal application is a multi-tenancy tool, accessible through a student mobile electronic device once the student has completed a student profile.

40. The system for bi-directional communication between a plurality of students and a plurality of PSEI in claim 25, wherein the PSEI portal application is resident on the PSEI server, embodied on a non-transitory computer readable medium as a software method.

41. The system for bi-directional communication between a plurality of students and a plurality of PSEI in claim 25, wherein the PSEI portal application is a multi-tenancy tool, accessible through the communication link, between the portal server and the PSEI server.

42. The system for bi-directional communication between a plurality of students and a plurality of PSEI in claim 25, wherein each student, accessing the method through a student portal application, can do at least one of the following actions: choose what information from the student's profile is shared with the public, the plurality of PSEI, and other students; access requirements for a plurality of degree-programs at a plurality of PSEI; interact, on a peer-to-peer basis, with other similarly situated students; research scholarships, internships, fellowships, and benefits; apply for scholarships, internships, fellowships, and benefits; review PSEI aspects such as courses, instructors, financial aid process, scheduling process, career counseling, and social life; access third-party goods and services such as career counseling, job placement, resume writing services, computers and electronics, software, and travel; and research and apply for jobs.

43. The system for bi-directional communication between a plurality of students and a plurality of PSEI in claim 42, wherein each student who is a former member of the United States' military, may access, through a student portal application, at least one additional software method relevant to former military members, such as GI Bill information; information and applications for benefits available only to veterans; preferences available only to veterans; special academic credits available to veterans; and licenses that are available to veterans.

44. The system for bi-directional communication between a plurality of students and a plurality of PSEI in claim 25, wherein each PSEI, accessing the method through a PSEI portal application, can choose targeted student profiles, called desired profiles, that correspond to the PSEI's internal recruitment requirements, such as grade point average, ACT/SAT test scores, demographic information, extracurricular participation, and affiliations.

45. The system for bi-directional communication between a plurality of students and a plurality of PSEI in claim 44, wherein a PSEI can offer students with desired profiles targeted inducements which include at least one of reduced tuition, financial aid, scholarships, early admission, and early decision.

46. The system for bi-directional communication between a plurality of students and a plurality of PSEI in claim 45, wherein students possessing the desired profiles can communicate acceptance or rejection of targeted inducements to the PSEI.

47. The system for bi-directional communication between a plurality of students and a plurality of PSEI in claim 44, wherein each PSEI can target communication to prospective students possessing desired profiles using a dashboard that contains information about at least one of the following: graduation rate, placement rate, acceptance rate, financial aid rates, financial aid averages, internship rate, and study abroad rates.

48. The system for bi-directional communication between a plurality of students and a plurality of PSEI in claim 47, wherein each PSEI can monitor student response to targeted communications, wherein the monitoring allows, at a minimum, the PSEI to see which students have received a communication, which students have responded to a communication, and which students have opened a hyperlink contained in the communication.
